(19) United States
(12) Patent Application Publication
(10) Pub. No.: US 2022/0268461 A1
(43) Pub. Date: Aug. 25, 2022

(54) FLOATING ULTRASONIC HUMIDIFIER CAPABLE OF GENERATING ULTRAVIOLET RAYS

(71) Applicant: MIRO Co., Ltd., Incheon (KR)

(72) Inventors: Dong Jin SEO, Incheon (KR); Yong Ju OH, Incheon (KR); Min Seok KIM, Incheon (KR)

(21) Appl. No.: 17/618,276

(22) PCT Filed: Mar. 5, 2021
(86) PCT No.: PCT/KR2021/002740

§ 371 Date: Dec. 10, 2021

(30) Foreign Application Priority Data
Aug. 27, 2020 (KR) 10-2020-0108464

(51) Int. Cl. F24F 6/12; F24F 11/00

(52) U.S. Cl. CPC F24F 6/12; F24F 11/0008; F24F 2006/006

(57) ABSTRACT

A floating ultrasonic humidifier capable of generating ultraviolet rays according to an embodiment of the present invention includes: a floating body configured to float in a water tub that accommodates water; an ultrasonic humidification generating module disposed in the floating body and configured to generate humidification particles by means of ultrasonic vibration; and an ultraviolet ray generating module provided in the floating body or the ultrasonic humidification generating module and configured to emit light within an ultraviolet region to a space in the water tub.

### TECHNICAL FIELD

Embodiments of the present invention relate to a floating ultrasonic humidifier, and more particularly, to a floating ultrasonic humidifier capable of generating ultraviolet rays.

### BACKGROUND ART

In general, a humidifier refers to a device for providing moisture to a dry interior. Depending on humidification methods, the humidifiers are classified into an ultrasonic humidifier using ultrasonic waves and a heating humidifier using a heater.

The ultrasonic humidifier converts water into fine water droplets using an ultrasonic vibrator installed in a water tub and then sprays the fine water droplets in an atomized state using a blower fan. In contrast, the heating humidifier vaporizes water using heat of a heater installed in a water tub and then sprays the vapor in an atomized state using a blower fan.

The two types of humidifiers are installed and used while being disposed on fixed installation surfaces, which causes a great problem of proliferation of bacteria and a problem with an operation of cleaning the humidifies. To solve these problems, natural humidifiers, which are comparatively easy to clean and manage, are widely used.

A floating humidifier, which is comparatively easy to clean and manage among the natural humidifiers, is widely used. The floating humidifier is movably installed in a water tub that accommodates water while floating on the water. The floating humidifier in the related art floats at a predetermined height in the water tub, converts the water introduced thereinto into fine water particles using an ultrasonic vibrator, and then discharges the water particles in an atomized state using a blower fan.

However, a temperature of the water in the water tub is raised during a process of creating humidification particles, which causes a problem of rapid proliferation of bacteria. A humidifier disinfectant is sometimes used to solve this problem, but the use of humidifier disinfectant is avoided because of harmful substances contained in the disinfectant.

Therefore, there is a need to develop a technology to optimize an environment in the water tub in which the floating humidifier is used without concern for damage to a user's health.

As a related art, there is Korean Patent No. 10-1400930 entitled ‘STERILIZING HUMIDIFIER WITH ULTRAVIOLET LIGHT EMITTING DIODE MODULE AND METHOD THEREOF’ (registered on May 22, 2014).

### DISCLOSURE

### Technical Problem

An embodiment of the present invention provides a floating ultrasonic humidifier capable of generating ultraviolet rays, in which a module capable of generating ultraviolet rays is embedded in a lower end of the floating ultrasonic humidifier, thereby performing both a humidification function and a function of sterilizing water accommodated in a water tub.

Technical problems to be solved by the present invention are not limited to the above-mentioned technical problem(s), and other technical problem(s), which are not mentioned above, may be clearly understood by those skilled in the art from the following descriptions.

### Technical Solution

A floating ultrasonic humidifier capable of generating ultraviolet rays according to an embodiment of the present invention includes: a floating body configured to float in a water tub that accommodates water; an ultrasonic humidification generating module disposed in the floating body and configured to generate humidification particles by means of ultrasonic vibration; and an ultraviolet ray generating module provided in the floating body or the ultrasonic humidification generating module and configured to emit light within an ultraviolet region to a space in the water tub.

The ultraviolet ray generating module according to the embodiment of the present invention may be embedded in a lower portion of the floating body or a lower portion of the ultrasonic humidification generating module.

The ultraviolet ray generating module according to the embodiment of the present invention may include one of an ultraviolet light-emitting lamp and an ultraviolet light-emitting element including an ultraviolet (UV) LED.

The floating ultrasonic humidifier capable of generating ultraviolet rays according to the embodiment of the present invention may further include: a detection unit configured to detect at least one of the amount of contact between moisture and the ultrasonic humidification generating module, the amount of water in the water tub, whether a lid of the water tub is opened or closed, and a motion of the ultraviolet ray generating module; and a control unit configured to control an operation of the ultraviolet ray generating module on the basis of a detection signal detected by the detection unit.

The control unit according to the embodiment of the present invention may stop the operation of the ultraviolet ray generating module when the control unit received, from the detection unit, a detection signal indicating that at least one of the amount of contact between moisture and the ultrasonic humidification generating module and the amount of water in the water tub is equal to or smaller than a preset critical value.

The control unit according to the embodiment of the present invention may stop the operation of the ultraviolet ray generating module when the control unit receives, from the detection unit, a detection signal indicating that the lid of the water tub is opened or closed.

The control unit according to the embodiment of the present invention may stop the operation of the ultraviolet ray generating module when the control unit receives, from the detection unit, a detection signal indicating that a central axis of the ultrasonic humidification generating module is inclined at a predetermined inclination angle with respect to a horizontal direction.

Other detailed matters of the exemplary embodiment are included in the detailed description and the accompanying drawings.

### Advantageous Effects

According to the embodiment of the present invention, the module capable of generating ultraviolet rays is embedded in the lower end of the floating ultrasonic humidifier to sterilize the water accommodated in the water tub, and the floating ultrasonic humidifier sprays clean water, which may be helpful to the user's health.

According to the embodiment of the present invention, the usage environment of the floating ultrasonic humidifier may be detected, and thus the operation of the module capable of generating ultraviolet rays provided in the humidifier may be effectively controlled.

### DESCRIPTION OF DRAWINGS

FIG. 1 is a view for explaining a state in which a floating ultrasonic humidifier capable of generating ultraviolet rays according to an embodiment of the present invention is used.

FIG. 2 is a perspective view for explaining the floating ultrasonic humidifier capable of generating ultraviolet rays according to the embodiment of the present invention.

FIG. 3A is a view illustrating an interior of the floating ultrasonic humidifier capable of generating ultraviolet rays according to the embodiment of the present invention.

FIG. 3B is a view illustrating an interior of a floating ultrasonic humidifier capable of generating ultraviolet rays according to another embodiment of the present invention.

### DESCRIPTION OF MAIN REFERENCE NUMERALS OF DRAWINGS

10: Water tub
110: Floating body
112: Opening hole
114: Power supply member
120: Ultrasonic humidification generating module
122: Vibration plate
130: Ultraviolet ray generating module
140: Detection unit
150: Control unit
160: Power supply source

### MODE FOR INVENTION

Advantages and/or features of the present invention and methods of achieving the advantages and features will be clear with reference to exemplary embodiments described in detail below together with the accompanying drawings. However, the present invention is not limited to the exemplary embodiments disclosed herein but will be implemented in various forms. The exemplary embodiments of the present invention are provided so that the present invention is completely disclosed, and a person with ordinary skill in the art to which the present invention pertains can fully understand the scope of the present invention. the present invention will be defined only by the scope of the appended claims. Like reference numerals indicate like constituent elements throughout the specification.

Hereinafter, exemplary embodiments of the present invention will be described in detail with reference to the accompanying drawings.

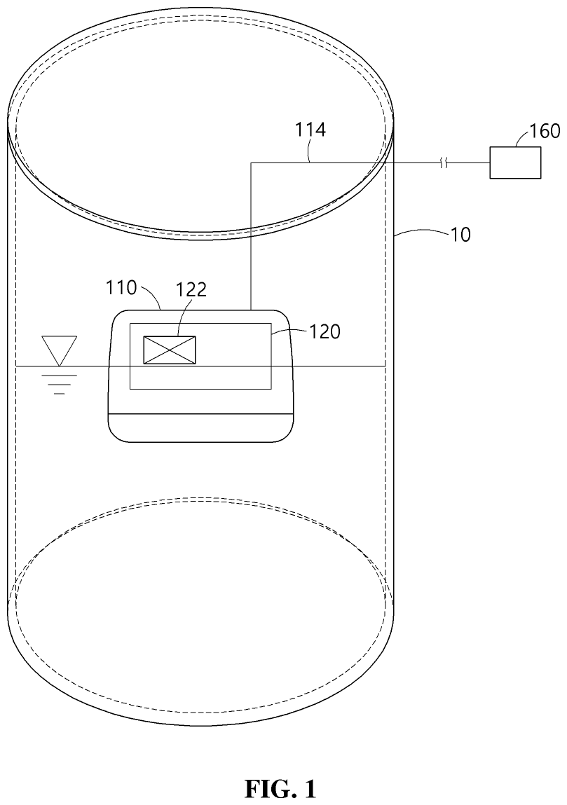

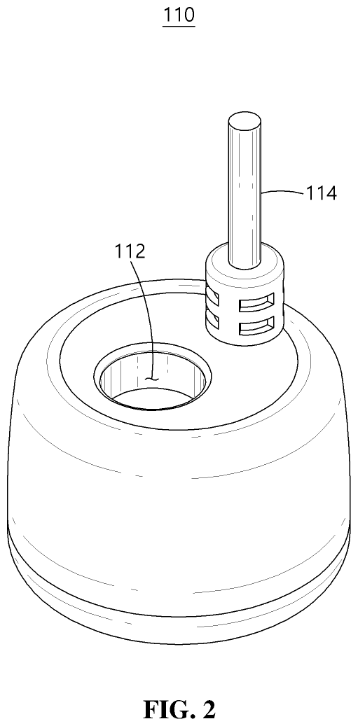

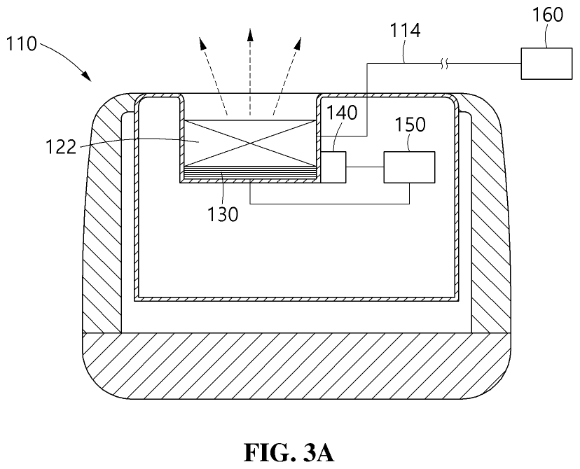

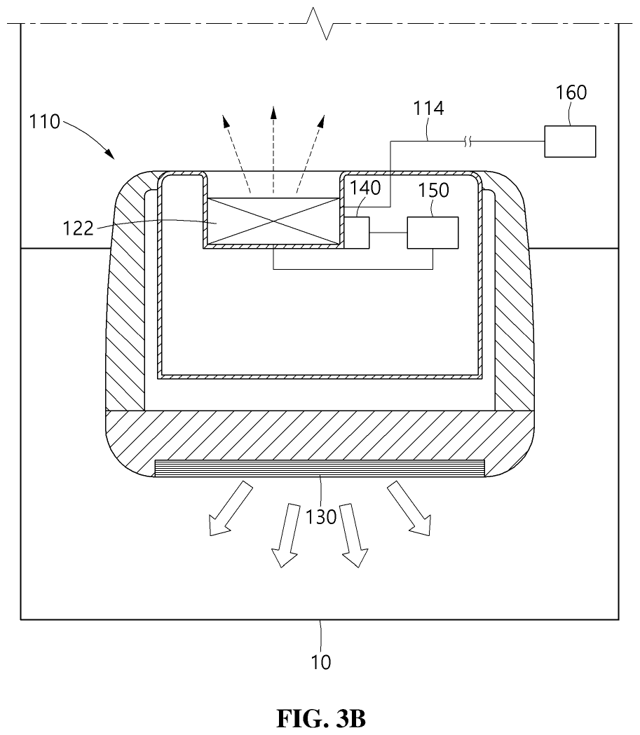

FIG. 1 is a view for explaining a state in which a floating ultrasonic humidifier capable of generating ultraviolet rays according to an embodiment of the present invention is used, FIG. 2 is a perspective view for explaining the floating ultrasonic humidifier capable of generating ultraviolet rays according to the embodiment of the present invention, FIG. 3A is a view illustrating an interior of the floating ultrasonic humidifier capable of generating ultraviolet rays according to the embodiment of the present invention, and FIG. 3B is a view illustrating an interior of a floating ultrasonic humidifier capable of generating ultraviolet rays according to another embodiment of the present invention.

Referring to FIGS. 1 and 2, a floating ultrasonic humidifier capable of generating ultraviolet rays according to an embodiment of the present invention may include a floating body 110, an ultrasonic humidification generating module 120, and an ultraviolet ray generating module 130.

The floating body 110 may float in a water tub 10 that provides an accommodation space that accommodates water for generating humidification.

In one embodiment, the floating body 110 may be made of a material such as synthetic resin or metal, but various materials capable of accommodating water may be selectively used.

Meanwhile, the water tub 10 may be made of a transparent or semi-transparent material so that a user may check a floating state of the floating body 110 with the naked eye. Further, as illustrated in the drawings, the water tub 10 has a cylindrical shape, but the water tub 10 may have other shapes, as necessary. For example, the water tub 10 may be formed in a hexahedral shape having a quadrangular cross-section.

In one embodiment, an opening hole 112 opened at a center thereof may be formed in an upper portion of the floating body 110, and an internal space for installing the ultrasonic humidification generating module 120 to be described below may be provided below the opened side. The floating body 110 may discharge humidification particles, generated by the ultrasonic humidification generating module 120, through the opening hole 112.

In one embodiment, an inlet port (not illustrated) may be provided in a lower portion of the floating body 110, and the water accommodated in the water tub 10 is introduced into the inlet port so that the humidification particles may be generated by the ultrasonic humidification generating module 120.

In one embodiment, the floating body 110 may have a power supply member 114. The power supply member 114 may serve to transmit power from an external power supply source 160 to operate the ultrasonic humidification generating module 120, the ultraviolet ray generating module, and a control unit 150 to be described below.

The ultrasonic humidification generating module 120 is disposed in the floating body 110 and generates the humidification particles using ultrasonic vibration.

In one embodiment, the ultrasonic humidification generating module 120 may be fixed or detachably installed in the internal space of the floating body 110.

In one embodiment, the ultrasonic humidification generating module 120 may have a vibration plate 122 that generates the ultrasonic vibration by being operated by the power transmitted from the outside. For reference, the ultrasonic humidification generating module 120 may be connected to the power supply member 114 through a separate cable for transmitting the power from the external power supply source 160.

The vibration plate 122 generates the ultrasonic vibration by being operated by the power transmitted from the outside, thereby atomizing the water accommodated in the water tub 10.

The ultraviolet ray generating module 130 may be provided at a lower end of the floating humidifier in consideration of the structural nature of the floating humidifier floating on the water. The ultraviolet ray generating module 130 may emit light within an ultraviolet region to a space in the water tub 10.

In one embodiment, the ultraviolet ray generating module 130 may be provided on the floating body 110 or the ultrasonic humidification generating module 120.

In one embodiment, as illustrated in FIG. 3A, the ultraviolet ray generating module 130 may be embedded in a lower portion of the ultrasonic humidification generating module 120. In this case, the lower portion of the floating body 110 is made of a material having light transmissivity or transparency, such that the ultraviolet rays generated by the ultraviolet ray generating module 130 may be sufficiently transmitted to the space in the water tub 10 while passing through the floating body 110.

In another embodiment, as illustrated in FIG. 3B, the ultraviolet ray generating module 130 may be embedded in the lower portion of the floating body 110.

Since the ultraviolet ray generating module 130 is provided in the lower portion of the floating body 110 or the lower portion of the ultrasonic humidification generating module 120 as described above, the accommodated water may be sufficiently sterilized even though a level of the water in the water tub 10 is lowered.

For reference, the position at which the ultraviolet ray generating module 130 is disposed is not limited to the above-mentioned positions. The ultraviolet ray generating module 130 may be provided a lateral portion or other positions on the floating body 110 or the ultrasonic humidification generating module 120.

In one embodiment, the ultraviolet ray generating module 130 may include one of an ultraviolet light-emitting lamp and an ultraviolet light-emitting element using an ultraviolet (UV) LED.

In one embodiment, the ultraviolet ray generating module 130 may be connected to the power supply member 114 through the separate cable for transmitting the power from the external power supply source 160. The ultraviolet ray generating module 130 may be connected in parallel with a cable connected to the ultrasonic humidification generating module 120. In another embodiment, the ultraviolet ray generating module 130 may be operated by a battery provided therein.

Meanwhile, the floating ultrasonic humidifier capable of generating ultraviolet rays according to the embodiment of the present invention may further include a detection unit 140 and the control unit 150.

The detection unit 140 may be provided in the form of a sensor for detecting a usage environment of the floating ultrasonic humidifier.

In one embodiment, the detection unit 140 may detect at least one of the amount of contact between moisture and the ultrasonic humidification generating module 120, the amount of water in the water tub 10, whether a lid of the water tub 10 is opened or closed, and a motion of the ultraviolet ray generating module 130. For example, the detection unit 140 may be disposed at a predetermined position on the ultrasonic humidification generating module 120 to detect the amount of contact between moisture and the ultrasonic humidification generating module 120. The detection unit 140 may be disposed at a predetermined position on the water tub 10 to detect the amount of water in the water tub 10 and whether the lid of the water tub 10 is opened or closed. The detection unit 140 may be disposed at a predetermined position on the ultraviolet ray generating module 130 to detect the motion of the ultraviolet ray generating module 130.

The control unit 150 may control an operation of the ultraviolet ray generating module 130 on the basis of a detection signal detected by the detection unit.

In one embodiment, the control unit 150 may be provided in the form of a circuit. In more detail, the control unit 150 may be a circuit disposed on a PCB having a predetermined size.

In this case, the control unit 150 may be embedded in the ultrasonic humidification generating module 120 or the ultraviolet ray generating module 130 or connected to the ultrasonic humidification generating module 120 or the ultraviolet ray generating module 130 by means of a bridge. In this case, the bridge may be implemented to have various shapes such as a flexible line shape or a fixed line shape, as necessary. In the embodiment, the control unit 150 may be formed to be surrounded by a sealing member (not illustrated) made of a waterproof material.

Meanwhile, the control unit 150 may receive a control signal in a wireless manner from an external adjuster (not illustrated), including a remote controller or a portable terminal, through a communication antenna (not illustrated) that may be provided on the floating body 110. Therefore, the control unit 150 may control the operation of the ultraviolet ray generating module 130 on the basis of a control signal received from the external adjuster in addition to the detection signal received from the detection unit 140.

Furthermore, the control unit 150 may be provided outside the floating body 110 and control an operation of the ultraviolet ray generating module 130. For example, the control unit 150 may be provided outside the floating body 110 in various ways. The control unit 150 may be mounted on an outer surface of the floating body 110, connected to the power supply source 160, or provided outside the water tub 10. In this case, the control unit 150 may operate the ultrasonic humidification generating module 120, the ultraviolet ray generating module 130, and the detection unit 140, which are provided in the floating body 110, by means of wired or wireless communication.

Hereinafter, various embodiments in which the control unit 150 controls the operation of the ultraviolet ray generating module 130 will be described.

In one embodiment, when the control unit 150 receives, from the detection unit 140, a detection signal indicating that at least one of the amount of contact between moisture and the ultrasonic humidification generating module 120 and the amount of water in the water tub 10 is equal to or smaller than a preset critical value, the control unit 150 may stop the operation of the ultraviolet ray generating module 130. Therefore, in a case in which the humidification function is difficult to perform because the ultrasonic humidification generating module 120 is positioned outside the water tub 10 or the amount of water in the water tub 10 is not sufficient, it is possible to prevent the ultraviolet ray generating module 130 from excessively operating or it is possible to protect a lifespan of the battery when the battery is provided in the ultraviolet ray generating module 130. Furthermore, even when the control unit 150 receives, from the detection unit 140, a detection signal indicating that at least one of the amount of contact between moisture and the ultrasonic humidification generating module 120 and the amount of water in the water tub 10 is equal to or larger than the preset critical value, the control unit 150 may stop the operation of the ultraviolet ray generating module 130. Therefore, in a case in which there is concern that the amount of water in the water tub 10 rapidly increases and the humidifier is pushed out of the water tub 10, the control unit may stop the operation of the ultraviolet ray generating module 130 in advance.

In still another embodiment, when the control unit 150 receives, from the detection unit 140, a detection signal indicating that the lid of the water tub 10 is opened or closed, the control unit 150 may stop the operation of the ultraviolet ray generating module 130. Therefore, when it is determined that an additional function, such as a function of cleaning the humidifier or a function of changing components of the humidifier other than the humidification function, is performed, it is possible to prevent the ultraviolet ray generating module 130 from excessively operating or it is possible to protect a lifespan of the battery when the battery is provided in the ultraviolet ray generating module 130.

In yet another embodiment, when the control unit 150 receives, from the detection unit 140, a detection signal indicating that a central axis of the ultrasonic humidification generating module 120 is inclined at a predetermined inclination angle with respect to a horizontal direction, the control unit 150 may stop the operation of the ultraviolet ray generating module 130. Therefore, in a case in which the humidification function is difficult to perform because the ultrasonic humidification generating module 120 is positioned outside the water tub 10 or the ultrasonic humidification generating module 120 is reversed in the water tub 10 while losing balance, it is possible to prevent the ultraviolet ray generating module 130 from excessively operating or it is possible to protect a lifespan of the battery when the battery is provided in the ultraviolet ray generating module 130.

According to the embodiment of the present invention described above, the module capable of generating ultraviolet rays is embedded in the lower end of the floating ultrasonic humidifier to sterilize the water accommodated in the water tub 10, and the floating ultrasonic humidifier sprays clean water, which may be helpful to the user's health.

In addition, according to the embodiment of the present invention, the usage environment of the floating ultrasonic humidifier may be detected, and thus the operation of the module capable of generating ultraviolet rays provided in the humidifier may be effectively controlled.

While the specific exemplary embodiments according to the present invention have been described above, various modifications may be made without departing from the scope of the present invention. Therefore, the scope of the present invention should not be limited to the described exemplary embodiments and should be defined by not only the claims to be described below, but also those equivalents to the claims.

While the present invention has been described above with reference to the limited exemplary embodiments and the drawings, the present invention is not limited to the exemplary embodiments and may be variously modified and altered from the disclosure by those skilled in the art to which the present invention pertains. Therefore, the spirit of the present invention should be defined only by the appended claims, and all modifications, equivalents, and alternatives fall within the scope and spirit of the present invention.

1. A floating ultrasonic humidifier capable of generating ultraviolet rays, the floating ultrasonic humidifier comprising:
a floating body configured to float in a water tub that accommodates water;
an ultrasonic humidification generating module disposed in the floating body and configured to generate humidification particles by means of ultrasonic vibration; and
an ultraviolet ray generating module provided in the floating body or the ultrasonic humidification generating module and configured to emit light within an ultraviolet region to a space in the water tub.

2. The floating ultrasonic humidifier of claim 1, wherein the ultraviolet ray generating module is embedded in a lower portion of the floating body or a lower portion of the ultrasonic humidification generating module.

3. The floating ultrasonic humidifier of claim 2, wherein the ultraviolet ray generating module comprises one of an ultraviolet light-emitting lamp and an ultraviolet light-emitting element including an ultraviolet (UV) LED.

4. The floating ultrasonic humidifier of claim 1, further comprising:
a detection unit configured to detect at least one of the amount of contact between moisture and the ultrasonic humidification generating module, the amount of water in the water tub, whether a lid of the water tub is opened or closed, and a motion of the ultraviolet ray generating module; and
a control unit configured to control an operation of the ultraviolet ray generating module on the basis of a detection signal detected by the detection unit.

5. The floating ultrasonic humidifier of claim 4, wherein the control unit stops the operation of the ultraviolet ray generating module when the control unit received, from the detection unit, a detection signal indicating that at least one of the amount of contact between moisture and the ultrasonic humidification generating module and the amount of water in the water tub is equal to or smaller than a preset critical value.

6. The floating ultrasonic humidifier of claim 4, wherein the control unit stops the operation of the ultraviolet ray generating module when the control unit receives, from the detection unit, a detection signal indicating that the lid of the water tub is opened or closed.

7. The floating ultrasonic humidifier of claim 4, wherein the control unit stops the operation of the ultraviolet ray generating module when the control unit receives, from the detection unit, a detection signal indicating that a central axis of the ultrasonic humidification generating module is inclined at a predetermined inclination angle with respect to a horizontal direction.
